(19) United States
(12) Patent Application Publication
(10) Pub. No.: US 2015/0091232 A1
(43) Pub. Date: Apr. 2, 2015

(54) Clamp Shoe

(71) Applicant: Global Contract Manufacturing, Inc., Union City, CA (US)

(72) Inventor: James Francis Meagher, Jr., Union City, CA (US)

(73) Assignee: Global Contract Manufacturing, Inc., Union City, CA (US)

(21) Appl. No.: 14/135,130

(22) Filed: Dec. 19, 2013

Related U.S. Application Data
(60) Provisional application No. 61/740,223, filed on Dec. 20, 2012.

(51) Int. Cl. B23Q 3/06; B23Q 3/10

(52) U.S. Cl. CPC B23Q 3/065; B23Q 3/103; B23Q 3/069
USPC 269/274; 269/271; 269/273

(57) ABSTRACT

A toe clamp primarily for machining operations is provided with a fitted clamp shoe that engages the tip of the toe clamp and preferably is held thereon by a clip. The clamp shoe is of a material softer than the work piece subject of the tooling operation, so that the clamping against the work piece does not damage the surface of the work piece. The material of the clamp shoe can be aluminum, brass, plastic, or other materials depending on the work piece that is being clamped.

### BACKGROUND OF THE INVENTION

This application claims benefit of provisional application No. 61/740,223, filed Dec. 20, 2012.

This invention concerns machining or tooling operations and equipment, and specifically relates to tooling clamps and especially a clamp commonly known as a toe clamp.

In machining or tooling operations, use is very commonly made of clamps that are used to hold a work piece in place during the tooling or machining operation. A particular type of tooling clamp in wide use for tooling operations is a toe clamp, typically a narrow clamping piece having a tapered toe or tip at its contacting end and with holes to receive two machine bolts such that pressure can be exerted on the work piece by the toe or tip.

When tooling clamps are used directly against a work piece, the work piece can be damaged from the hard surface of the clamp and the force exerted by the clamp against the work piece surface. In the prior art, a typical solution was to place a small piece of aluminum or plastic sheeting, e.g. a rectangular piece, between the clamp toe and the work piece. These pads are not attached to the clamp and are loose from the clamp during setup, so that it can be cumbersome to properly locate them relative to the work piece and the clamp.

### SUMMARY OF THE INVENTION

The invention provides a clamp shoe for tooling clamps, particularly toe clamps, that overcomes the problems described above. The clamp shoe consists of a protective pad that is attached directly to the clamp itself, particularly the tip of a toe clamp, with a bottom bearing area to engage against a work piece. By this device the protection of a work piece solves the problem of work piece clamp damage by the use of fewer components to be held and located during the clamping process. Existing clamps can be provided with new clamp shoes relatively easily, with a quick attachment to the working end of the clamp, thus changing the clamp's effective compliancy or surface compatibility with the work piece. The softer clamp shoe will not damage the work piece surface.

In addition, the clamp shoe serves as an inexpensive wear item, protecting the more valuable tooling clamp itself from damage. When a clamp shoe is worn or damaged, it can simply be removed or replaced with another shoe.

In different embodiments of the invention, the clamp shoe can be provided either as a loosely fitting or tightly fitting attachment. The loose version is retained to the end or tip of the tooling clamp, but with a small amount of permitted movement, which may be desirable in the work piece clamping process (e.g., this permitted relative movement can avoid scratching of the work piece surface). On the other hand, a clamp shoe of the invention may be tightened to the tooling clamp more snugly if desired. Preferably a deformable tang or tab is integrally formed on the clamp shoe, this tab being configured to engage onto the working end tip of the toe clamp. It can be snapped into place on the clamp by firmly tapping the clamp, with the shoe, against a surface, and the shoe will remain on the toe clamp.

Accordingly, it is among the objects of the invention to solve the problem of work piece damage from a tooling clamp, and especially a toe clamp which engages firmly against the surface of the work piece to hold the piece in place for the tooling or machining operation. This is accomplished with a clamp shoe of a material softer than the work piece, the clamp shoe being shaped so as to engage over the end of a work piece tip, with provision for retaining the clamp shoe thereon, and with a bottom bearing area to engage against a work piece. These and other objects, advantages and features of the invention will be apparent from the following description of a preferred embodiment, considered along with the accompanying drawings.

### DESCRIPTION OF THE DRAWINGS

FIG. 1 is a perspective view showing a tooling clamp, specifically a toe clamp, being used to hold a work piece in place for an operation, in accordance with prior art.

FIG. 2 is a view showing a similar toe clamp and illustrating the invention.

FIGS. 3 and 4 are perspective views showing the clamp shoe of the invention.

FIG. 5 is a side view showing the clamp shoe.

FIG. 6 is a perspective view showing a toe clamp fitted with the clamp shoe of the invention.

FIG. 7 is a perspective view showing the bottom of a typical toe clamp of the type shown in FIG. 6, illustrating structure which cooperates with the invention.

FIG. 8 is a perspective view similar to FIG. 7, showing the clamp shoe of the invention fitted onto the toe clamp.

### DESCRIPTION OF PREFERRED EMBODIMENTS

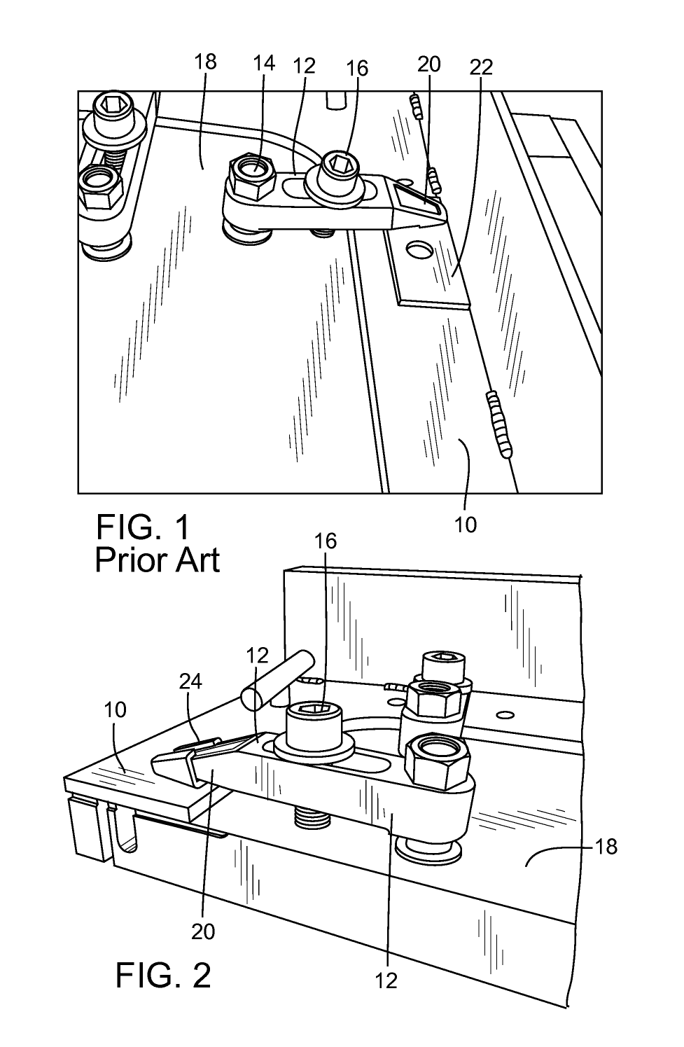

FIG. 1 shows a typical prior art arrangement for holding a work piece 10 in place for a tooling operation. A tooling clamp 12, in this case a toe clamp, is held by two bolts 14 and 16 on a work table or platform 18, so that the foot or tip 20 of the toe clamp can bear downwardly, with the bolt 16 being adjustable to apply downward pressure as desired. To avoid damage to the work piece 10, a small piece 22 of material which is softer than the work piece is inserted between the clamp shoe tip 20 and the work piece, as shown. This might be a small rectangle of aluminum or plastic, for example.

As explained above, this practice is cumbersome. FIG. 2 shows the invention, with the toe clamp 12 being fitted with a clamp shoe 24 of the invention. The clamp shoe 24 is fitted especially to the particular clamp to which it is applied, and is made of a material softer than that of the work piece 10. The clamp shoe may be formed of a plastic material, for example. It could be a relatively soft metal, such as aluminum.

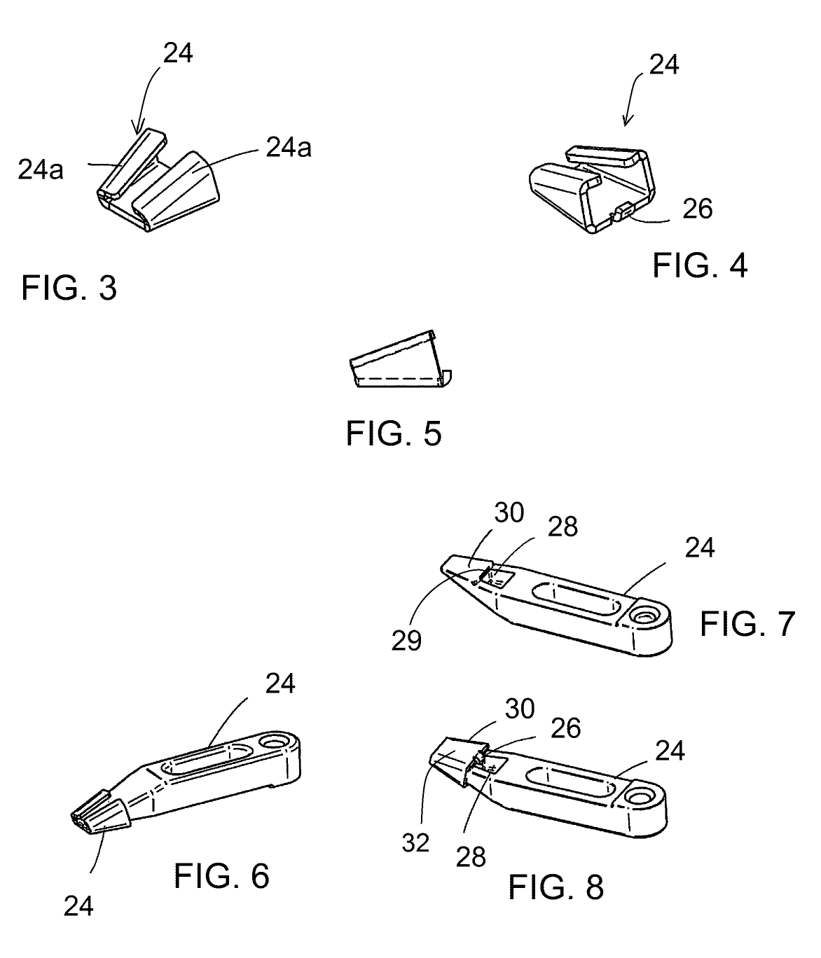

FIGS. 3, 4 and 5 show a clamp shoe 24 according to the invention. The shoe in this case is fitted to the tip or foot end of a toe clamp of the type shown in FIGS. 1 and 2 and also FIGS. 6-8. Thus, the shape defines a tapered interior, narrower at the extreme tip and with sides 24a that wrap around the toe clamp's tip so as to be retained thereon. FIG. 4 shows a tang 26 on and integrally formed with the clamp shoe, positioned for retention of the shoe on the toe clamp. In the case of a plastic clamp shoe, which can be of a memory-retaining plastic material, the tang 26 can be bent and deformed somewhat as the shoe is placed on the toe clamp, after which it will engage with a surface of the clamp. FIG. 5 shows the clamp shoe in side view.

FIG. 6 shows the clamp shoe 24 engaged on the toe clamp 24, of the type shown in the previous drawings. FIG. 7 shows the bottom side of the toe clamp itself, revealing a cavity 28 on the underside of the foot or tip of the toe clamp, just behind a bearing area 30 at the bottom front of the toe clamp, this area 30 being designed for applying force against a work piece.

FIG. 8 shows the toe clamp 24 fitted with the clamp shoe 30, again from the bottom of the toe clamp, and revealing the tang 26 extending into the recess 28, or against an edge or ledge 29, retaining the shoe in place. If the clamp shoe is formed of a compliant metal such as aluminum, the tang 26 could be bent down into the recess 28 after the shoe is slipped onto the tip of the toe clamp. More preferably the tang 26, being short in length, simply moves somewhat by slight deformation of the clamp shoe as it is forced over the toe clamp. In fact the shoe can be inserted loosely onto the tip of the toe clamp, then snapped into place by tapping the toe clamp with shoe down against a surface, causing the tang to snap into place. Similarly, if the shoe is of a pliable plastic, the tang 26 can be formed in the engaging position but forced aside as the clamp shoe is installed, then allowed to settle or snap into the recess, or against a ledge. The clamp shoe's bearing area is shown at 32. As explained above, the shoe can be made to fit loosely, to permit some movement relative to the toe clamp, or it can be snugly fitted.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

I claim:

1. On a tooling clamp used for engaging against a work piece to hold the work piece against a table or other surface during a tooling or machining operation, the improvement comprising a protective pad fitted and retained onto an end of the tooling clamp so as to at least partially envelop the end of the tooling clamp, the pad being of material softer than the work piece, whereby force exerted by the tooling clamp will not damage the work piece during the tooling or machining operation.

2. The improvement as defined in claim 1, wherein the tooling clamp is a toe clamp having a tapered tip, diminishing in both height and width toward a remote end of the tapered tip, and the protective pad comprising a shoe shaped to fit closely over an end region of the tapered tip so as to extend across the bottom of the tapered tip.

3. The improvement as defined in claim 2, wherein the shoe is discontinuous at a top side of the shoe, with flanges extending over a top side of the tapered tip but defining a gap between the flanges.

4. The improvement defined as in claim 2, wherein the toe clamp has holes spaced back from the tapered tip, for engaging bolts through the toe clamp, to pull the toe clamp down toward a work table or platform so as to apply force engaging the tapered tip down against a work piece.

5. The improvement as defined in claim 2, wherein the shoe includes a tang integrally formed as part of the shoe, positioned to engage against an edge on the toe clamp when fully installed, so as to prevent the shoe from slipping off the toe clamp.

6. The improvement as defined in claim 2, wherein the shoe is formed of plastic.

7. The improvement as defined in claim 2, wherein the shoe is formed of soft aluminum.

8. The improvement as defined in claim 1, wherein the protective pad is formed of plastic.

9. The improvement as defined in claim 1, wherein the protective pad is formed of soft aluminum.

10. The improvement as defined in claim 1, wherein the protective pad includes a deformable tang integrally formed as part of the pad, positioned to engage against an edge on the tooling clamp when fully installed, so as to prevent the pad from slipping off the tooling clamp.

11. The improvement as defined in claim 1, wherein the protective pad is loosely fitted on the end of the tooling clamp to permit some relative movement between the tooling clamp and the pad.

12. The improvement as defined in claim 1, wherein the protective pad is tightly fitted onto the end of the tooling clamp.

13. The improvement as defined in claim 2, wherein the shoe is loosely fitted on the end of the tooling clamp to permit some relative movement between the tooling clamp and the shoe.

14. The improvement as defined in claim 1, wherein the tooling clamp is a toe clamp, with a generally wedge shaped end having a flat bottom bearing area, and the protective pad comprising a clamp shoe complementarily shaped to slip over the wedge shaped end of the toe clamp so as to fit closely over the wedge shaped end and to extend across the bottom of the wedge shaped end.

15. The improvement as defined in claim 14, the toe clamp having at its bottom side a ledge, edge or recess adjacent to the flat bottom bearing area and against which or into which a tang of the clamp shoe engages so as to retain the clamp shoe on the end of the toe clamp.
